(19) United States
(12) Patent Application Publication
(10) Pub. No.: US 2004/0009328 A1
(43) Pub. Date: Jan. 15, 2004

(54) Grounding floor tile

(76) Inventor: Kuang-Hua Kung, Taoyuan (TW)

Correspondence Address: BACON & THOMAS, PLLC, 625 SLATERS LANE, FOURTH FLOOR, ALEXANDRIA, VA, 22314

(21) Appl. No.: 10/192,620

(22) Filed: Jul. 11, 2002

(51) Int. Cl. B32B 3/10

(52) U.S. Cl. 428/138

(57) ABSTRACT

A grounding floor tile is constructed to include a flat conducting bottom layer of electrically conducting material, a perforated transparent protective top layer, and a perforated colored thin-film intermediate layer bonded between the flat conducting bottom layer and the perforated transparent protective top layer, the colored thin-film intermediate layer having a top surface printed with a pattern and through holes respectively aligned with through holes of the perforated transparent protective top layer.

### BACKGROUND OF THE INVENTION

1. Field of the Invention

The present invention relates to a floor tile and, more particularly, to a grounding floor tile for grounding.

2. Description of the Related Art

Following fast development of electronic industry and computer-controlled office operation systems, electrostatic damages are frequently heard. Therefore, it is important to eliminate static electricity in high precision industry. According to one conventional method, electrically conductive material is mixed with polyurethane paint, and then the electrically conductive mixture is applied to the surface of the floor, forming a grounding floor. According to another conventional method, electrically conductive material is mixed with plastics, and then the electrically conductive mixture is molded into electrically conductive floor tiles, and then the electrically conductive floor tiles are bonded to the floor, forming a grounding floor. Grounding floors made according to these conventional methods are less attractive.

### SUMMARY OF THE INVENTION

The present invention has been accomplished under the circumstances in view. It is therefore the main object of the present invention to provide a grounding floor tile that effectively conducts free static electricity to the ground. It is another object of the present invention to provide a grounding floor tile, which can be made to show any of a variety of patterns. To achieve these and other objects of the present invention, the grounding floor tile comprises a flat conducting bottom layer of electrically conducting material, the flat conducting bottom layer having a top surface; a colored thin-film intermediate layer, the colored thin-film intermediate layer having a top surface printed with a pattern, a bottom surface bonded to the top surface of the flat conducting bottom layer, and a plurality of through holes extended through the top surface and bottom surface thereof; and a transparent protective top layer bonded to the top surface of the colored thin-film intermediate layer, the transparent protective top layer having a plurality of through holes extended through top and bottom surface thereof and respectively aligned with the through holes of the colored thin-film intermediate layer, the through holes of the transparent protective top layer having a diameter equal to the through holes of the colored thin-film intermediate layer.

### BRIEF DESCRIPTION OF THE DRAWINGS

FIG. 1 is an exploded view of a grounding floor tile according to the present invention; and

FIG. 2 is an elevational assembly view of the grounding floor tile according to the present invention.

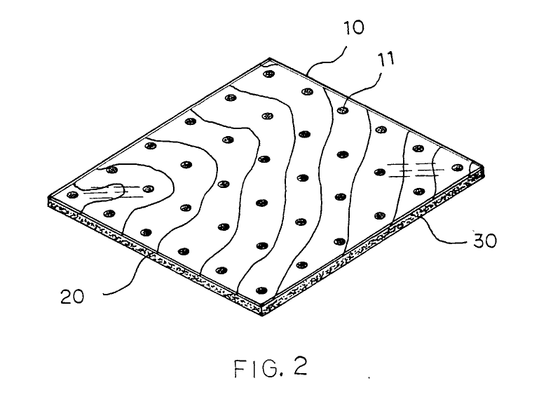

### DETAILED DESCRIPTION OF THE PREFERRED EMBODIMENT

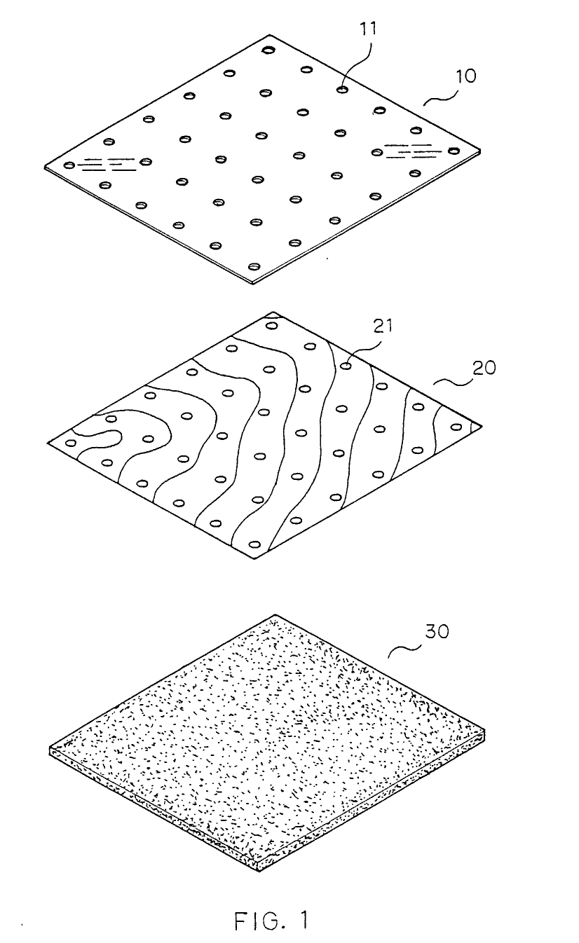

Referring to FIGS. 1 and 3, a grounding floor tile is shown comprised of a protective top layer 10, a colored intermediate layer 20, and a conducting bottom layer 30. The protective top layer 10 is a perforated transparent sheet member made of wear-resisting material, having transversely longitudinally aligned through holes 11. In order to achieve ESD (electrostatic discharge)<10⁹ Ω/cm², the diameter of the through holes 11 is set at about 1.5 mm, and the pitch between each two adjacent through holes 11 is about 1.5 cm.

The colored intermediate layer 20 is a thin film member having a top surface printed with a pattern and bonded to the bottom surface of the protective top layer 10, and a plurality of through holes 21 respectively disposed in vertical alignment with the through holes 11 of the protective top layer 10. The diameter of the through holes 21 of the colored intermediate layer 20 is equal to the through holes 11 of the protective top layer 10.

The conducting bottom layer 30 is a flat plate of electrically conducting material having a certain thickness and bonded to the bottom surface of the colored intermediate layer 20.

When the protective top layer 10, the colored intermediate layer 20 and the conducting bottom layer 30 fastened together by heat sealing, a grounding floor tile is made showing a particular pattern.

According to the present preferred embodiment, the protective top layer 10 and the colored intermediate layer 20 are respectively molded from polyvinyl chloride. The conducting bottom layer 30 is molded from a mixture containing polyvinyl chloride and electrically conductive carbon, and adapted for conducting static electricity and reinforcing the structural strength of the protective top layer 10 and the colored intermediate layer 20. Further, electrically conductive metal powder or fibers may be used instead of electrically conductive carbon and polyvinyl chloride respectively.

The pattern of the printing on the top surface of the colored intermediate layer 20 can be made by means of photographic reproduction.

When in use, the grounding floor tile is fixedly fastened to a metal floor rack. When free statistic electricity contacted the grounding floor tile, it is immediately transmitted through the conducting bottom layer 30 and the metal floor rack to the outdoor ground.

A prototype of grounding floor tile has been constructed with the features of FIGS. 1˜2. The grounding floor tile functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A grounding floor tile comprising:
a flat conducting bottom layer of electrically conducting material, said flat conducting bottom layer having a top surface;
a colored thin-film intermediate layer, said colored thin-film intermediate layer having a top surface printed with a pattern, a bottom surface bonded to the top surface of said flat conducting bottom layer, and a plurality of through holes extended through the top surface and bottom surface thereof; and
a transparent protective top layer bonded to the top surface of said colored thin-film intermediate layer, said transparent protective top layer having a plurality of through holes extended through top and bottom surface thereof and respectively aligned with the through holes of said colored thin-film intermediate layer, the through holes of said transparent protective top layer having a diameter equal to the through holes of said colored thin-film intermediate layer.

2. The grounding floor tile as claimed in claim 1, wherein the diameter of the through holes of said protective top layer and said colored thin-film intermediate layer is about 1.5 mm.

3. The grounding floor tile as claimed in claim 1, wherein the through holes of said protective top layer are spaced from one another at the pitch of about 1.5 cm.

4. The grounding floor tile as claimed in claim 1, wherein said protective top layer is molded from polyvinyl chloride.

5. The grounding floor tile as claimed in claim 1, wherein said colored thin-film intermediate layer is molded from polyvinyl chloride.

6. The grounding floor tile as claimed in claim 1, wherein said flat conducting bottom layer is molded from a mixture containing polyvinyl chloride and electrically conductive carbon.

7. The grounding floor tile as claimed in claim 1, wherein said flat conducting bottom layer is molded from a mixture containing polyvinyl chloride and electrically conductive fibers.
